(19) United States
(12) Patent Application Publication
(10) Pub. No.: US 2006/0047513 A1
(43) Pub. Date: Mar. 2, 2006

(54) Voice-activated remote control system and method

(75) Inventor: Niem-Tsu Chen, Taipei (TW)

Correspondence Address: GENUS LAW GROUP;LOWE HAUPTMAN & BERNER, LLP, 1700 DIAGONAL ROAD, SUITE 300, ALEXANDRIA, VA, 22314, US

(73) Assignee: INVENTEC MULTIMEDIA & TELECOM CORPORATION

(21) Appl. No.: 11/090,021

(22) Filed: Mar. 28, 2005

(30) Foreign Application Priority Data
Sep. 2, 2004 (TW) 93126524

(51) Int. Cl. G10L 17/00

(52) U.S. Cl. 704/246

(57) ABSTRACT

A wireless remote control system and method, by which a user may handle devices with different communication interfaces in voice, has been disclosed. The control system includes: a receiver, which receives a user's voice order. A voice process and recognition system, which recognizes the contents of the voice order to generate a control code. A communication module, which encodes the control code and transmits it in a particular wireless communication format to a controllable device for executing the user's order. Herein, the voice process and recognition system further comprises of three major parts: a signal process module, which converts the voice order into a digital voice signal. A speech recognition module, which analyzes the digital voice signal to obtain a service function in accordance with a service function file. And a code synthesizer generates the control code according to said service function.

### BACKGROUND OF THE INVENTION

1. Field of the Invention

The invention relates to a wireless remote control system. More particularly, the invention relates to a voice-activated remote control system and method for wireless remotely controlling different household appliances and information apparatus.

2. Description of the Prior Art

It's often seen that to utilize wireless communication techniques for remotely controlling every kind of electromechanical devices, such as television set, air conditioner, DVD player, or Hi-Fi equipment . . . etc. Infrared ray data access (IrDA) is one of the most popular wireless techniques, because IrDA is cheap and be easily designed, many household appliances adopt it for wireless remote controlling. Furthermore, in recent years, microwave communication makes progress rapidly with the development of semiconductor manufacturing, and many wireless communication techniques are proposed, i.e. Bluetooth, IEEE. 802.11 for WLAN, or WAP. Because wireless communication technologies are broadly used in many present household appliances and information apparatus for providing convenient remote access services, more and more electromechanical products offer remote controller. It's not bad if there are only one or two remote controllers in your living room, but when the numbers are increased (i.e., you have air conditioner's, DVD player's, TV's, and Hi-Fi audio's remote controllers in your living room), it becomes an awful work and it's an annoyance that a person has to find the right one each time when he intends to control a specific machine. Besides, more remote controllers will occupy more space, and the management thereof becomes more inconvenient.

In addition, most remote controllers have touch buttons, i.e. TV's and DVD player's, and the user puts stress on the buttons to give each kind of control orders to their corresponding machine. However, regular manipulation may cause exhausted elasticity of the button, thereby damaging the remote controller and reducing its usage lifespan.

Furthermore, there are usually lots of selection buttons on the remote controller of saying machines (TV set, DVD player . . . etc.). When the user intends to execute some complicated functions, he has to put right buttons incorrect sequence, sometimes it's a difficult thing to people. Therefore, for overcoming foregoing drawbacks, a voice-activated remote control system is proposed in the invention.

### SUMMARY OF THE INVENTION

Accordingly, an object of the invention is to provide a remote control system, which could solve the inconvenience and the management problems of conventional remote control systems (each machine has its own remote controller).

Besides, an another object of the invention is to provide a voice-activated remote control system, which won't suffer from the exhausted elasticity of the touch buttons in conventional remote controllers.

The present voice-activated remote control system comprises: a receiver, which receives a user's voice order. A voice process and recognition system, which recognizes the contents of the voice order to generate a control code. A communication module, which encodes the control code and transmits it in a particular wireless communication format to a controllable device for executing the user's order. Herein, the voice process and recognition system further comprises of three major parts: a signal process module, which converts the voice order into a digital voice signal. A speech recognition module, which analyzes the digital voice signal to obtain a service function in accordance with a service function file. And a code synthesizer generates the control code according to said service function.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 illustrates the system architecture of the present voice-activated remote control system;

FIG. 2 illustrates the flow chart of a voice-activated remote control method;

FIG. 3 illustrates the diagram of a Bluetooth piconet;

FIG. 4 illustrates the system architecture for a Bluetooth voice-activated remote control system; and

FIG. 5 illustrates the flow chart of the Bluetooth remote control system in FIG. 4.

### DETAILED DESCRIPTION OF THE INVENTION

Some preferred embodiments of the present invention will be described in detail in the following. However, beside the detailed description, the present invention can also be applied widely in other embodiments and the scope of the present invention is only limited by the appended claims.

Moreover, some irrelevant details are not drawn in order to make the illustrations concise and to provide a clear description for easily understanding the present invention.

The principle of voice control is that, according to the signal processing and the speech recognition technologies, a human's voice could be transformed into electronic signals and be converted into the languages that a machine could understand, so that the machine could execute the desired function of the users when they just “talk”. “Signal process” is a rough term, basically it includes, in the technique area, at least the voice sampling, analog/digital signal conversion, and the data compression technologies. As to speech recognition, it is the technology designed to recognize the sounds of human speech and convert them into digital signals for processing as input by a computing device, especially the computer. Since the two technologies are well-developed nowadays and well-known to skilled persons, their details won't be discussed in the following descriptions.

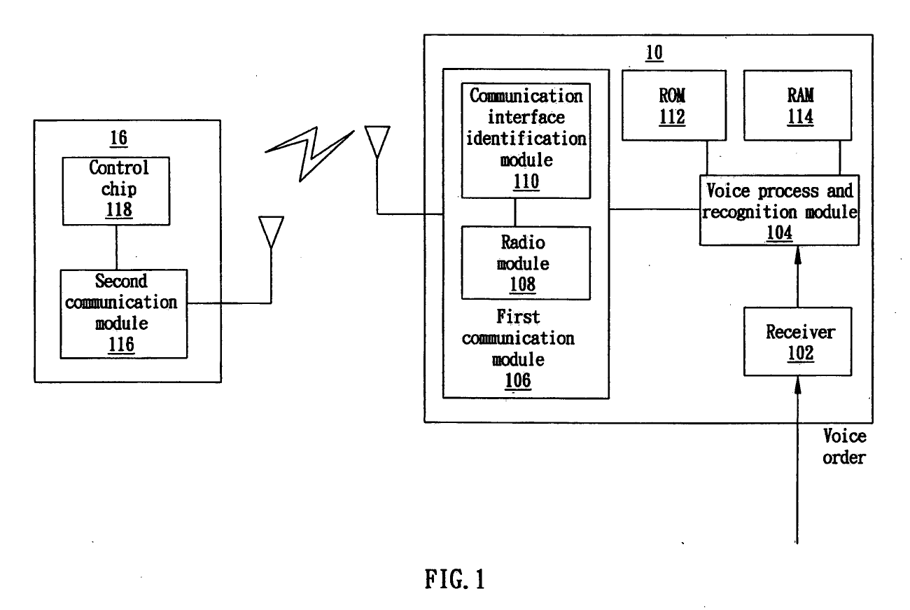

FIG. 1 illustrates the diagram for the present voice-activated remote control system, which has a remote controller 10 and a controllable device 16 herein. The remote controller 10 comprises: a receiver 102 receives a user's voice order. A voice process and recognition system 104, which is used to recognize the contents of the voice order and accordingly generates a corresponding control code. A first communication module 106 electrically coupling with the voice process and recognition system 104, which transmits signals with specific radio format to a designate controllable device 16. The first communication module 106 further comprises a communication interface identification module 110 for identifying the communication interfaces of controllable devices, and a radio module 108 for emitting radio signals. A rewritable and programmable ROM 112, which is used to store the user's voice training records and a service function file for acquiring the desired service function of the user. And a RAM 114, which temporally stores input voice signals and each kind of computing data. The controllable device 16 includes at least a second communication module 116 and a control unit 118, in which the second communication module 116 is used to communicate with remote controller 16 and the control chip 118 is used to drive the controllable device 16.

The receiver 102 may be a microphone, which converts the sound waves of a user's voice order into analog electronic voice signals and then inputs the present remote controller. Besides, the receiver 102 could also be simply an I/O interface suchlike the RJ45 plug, which may connect to the network for receiving data or even the voice order.

The voice process and recognition system 104 includes three major parts: a signal process module, a speech recognition module, and a code synthesizer (not shown in the drawing). Signal process module converts the input analog voice signals from the receiver 102 into digital voice signals. Besides, it further compresses the digital voice signals in advance for reducing the data size. Pulse code modulation (PCM), especially the adaptive differential PCM (ADPCM), is one of the most popular voice signal sampling techniques. Because ADPCM not only achieves the goals for analog/digital voice signal conversion but also has less redundant encoding, it's preferred in many audio-related technical fields.

Speech recognition module recognizes the contents of user's voice order to acquire the desired service function of the user. In general, speech recognition module analyzes the spectrum of the user's voice via comparing the digital voice signals with voice training records, thereby obtaining possible order's content. Voice training records contain the vocal characteristics of specific wording (i.e., the wording “turn on”, “TV”), especially the vocal characteristics in frequency domain, so the speech recognition module may correspond an inputted voice order to specific wordings accordingly. Moreover, the speech recognition module will try to combine all the recognized wordings into a service function. Aforementioned voice training records and relevant algorithms for forming a meaningful service function are recorded, moreover, in a service function file for representation.

Generally speaking, the often-seen wordings for controlling electromechanical devices in a household environment may include: device ID (i.e., “TV”, “refrigerator”, “air condition” . . . etc.), designate operations (i.e., TV “turn on”, air conditioner “cool down” . . . etc.), and target values of designate operations (i.e., temperature or humidity of the air conditioner) . . . etc. Hence, the service function file must have relevant speech characteristics of those wordings, so that the speech recognition module may recognize the content of the voice order by this voice template.

When the spectrum analysis result shows no specific wording matches the input voice order, or the recognized wordings could not form a meaningful service function, the input voice order may be wrong and unsupported in the system, the remote controller 10 will ask the user re-inputting his voice order. Moreover, when the corresponding wordings to input the voice order are found and the service function is acquired but the designate controllable device 16 doesn't support the service function, the user has to re-input voice order, too. The way that the remote controller 10 notices the user may be done by displaying messages on a display panel (i.e. a LCD panel) or generating a “beep” sound via a speaker, which is not limited in the invention.

The service function file is stored in ROM 112. Since different people have different vocal characteristics, it's better that a user performs voice training before using the present device/system. After finishing the voice training, the service function file updates and restores the ROM 112. Of course, a service function, specially the voice training records, may not only update directly on the remote controller, but also be inputted from external devices through an I/O interface, which is unlimited in the invention.

Furthermore, the supportive service functions may expand in advance. For example, we have a new controllable device such as a video player, therefore we may have to update the service function file for recognizing the relevant wordings. As mentioned above, the update service function file may import the ROM 112 through an I/O interface.

After analyzing the contents of the voice order and acquiring the corresponding service function thereof, the code synthesizer encodes the service function into digital control codes and transmits to the first communication module 106. For instance, the wording “turn on” relates to a service function for initializing a device, and the code synthesizer may encode it into a sequence of binary control code 0110 and then transmit the binary code to the first communication module 106. Next, the first communication module 106 receives the binary control code and transmits to the designate controllable device 16.

The main purpose of first communication module 106 is to establish and transmit the control code to the designate controllable device in particular radio format, i.e. the Bluetooth, IEEE 802.11a/g, or IrDA. Usually, radio module 108 may contain a plurality of wireless communication interfaces for communicating with those controllable devices 16 having different communication interfaces. Since each controllable device might have different communication interface respectively, the communication interface identification module 110 identifies which radio format the designate device it has, thereby transmitting the corresponding radio signals to the designate devices. Besides, the first communication module 106 may further have encryption/decryption circuits for protecting the communication.

In general, most controllable devices 16 include single communication interface, in other words, the second communication module 116 supports single radio format only. Through the second communication module 116, the controllable device 16 receives the radio signals from remote controller 10 and demodulates/decodes the radio signals into the control code. In addition, the controllable device 16 delivers information thereof (i.e., parameters for communication, the supportive service function . . . etc.) to the remote controller 10 via second communication module 116. Finally, the control chip 118 of the controllable device 16 receives the control code from the second communication module 116, and then executes the desired service function of the user accordingly.

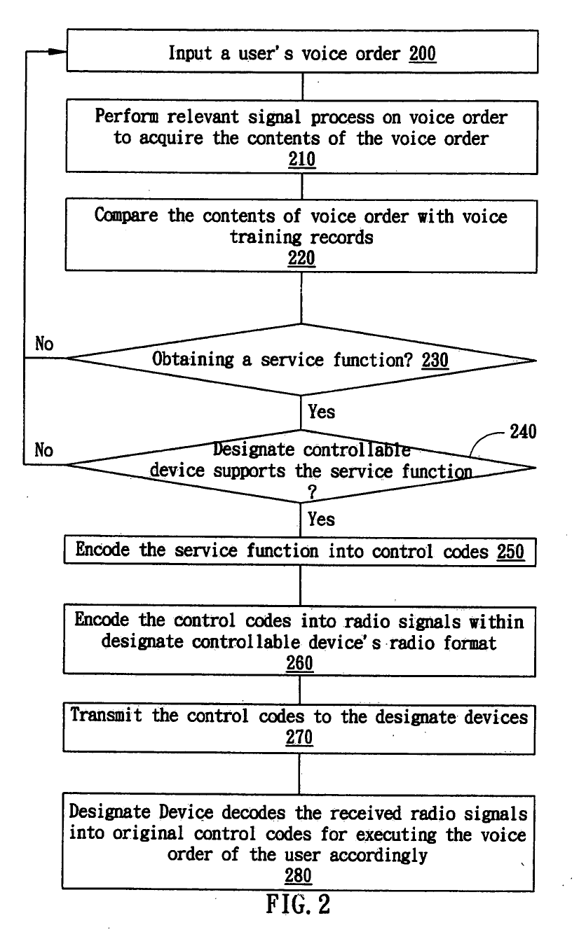

Referring to FIG. 2, a voice-activated remote control method is disclosed. Firstly, through a receiver, and user's voice order inputs into a wireless control device (step 200). Next, the said wireless control device performs voice signal process and speech recognition on the input voice order for recognizing the content of voice order (step 210). Extract the content of voice order by comparing the vocal characteristics of the voice order with voice training records and get the desired service function of the user (step 220). Identify if the content of voice order may form a meaningful service function (step 230). If the answer is negative or the designate device does not support the service function (step 240), ask the user reentry his voice order. Otherwise, generate a control code if a complete meaningful service function is obtained (step 250). Wireless control device identifies the communication interfaces of designate controllable device and encodes the control code in specific radio format (step 260). Next, a radio signal is transmitted to designate a controllable device through corresponding communication interface (step 270). Finally, the designate controllable device decodes the radio signal into original control code for executing the user's voice order (step 280).

The ways that the wireless control device identifies the communication interface of controllable device are unlimited. For example, the communication modules of all controllable devices broadcast their information (i.e., ID, communication interface, current status . . . etc.) to air. The wireless control device listens/receives those broadcast signals and record them in its own memory. Next, when a user intends to send control orders to a designate controllable device, the wireless control device may determine which device and communication interface to communicate with. It's noticed that the invention is not limited to the aforementioned example.

Bluetooth is a short-range, low-cost wireless communication technology originated by several companies (NOKIA, MOTOROLA, ERICCSON . . . etc.) in early 90's, which is originally used to replace the transmission line/cables in office or household environment. Some characteristics of Bluetooth technology make it suitable to wireless remote control system, for example, the usage of spread spectrum and frequency hopping techniques make Bluetooth resistive of interference and noise and more robust. 2.45 GHz ISM transmission band of Bluetooth is universally operative, hence the manufacture (service providers) has no need to file a license as well as GSM or CDMA. All Bluetooth devices have the same class, so a Bluetooth network composes of similar Bluetooth device. And, the ad-hoc network architecture makes the Bluetooth network being easily established. Moreover, compared to IrDA, Bluetooth is nondirectional, basically unblockable by obstacles, and has a longer transmission range. Besides, with compared to IEEE 802.11, Bluetooth is much cheaper. Hence it's preferable in the embodiment of the invention.

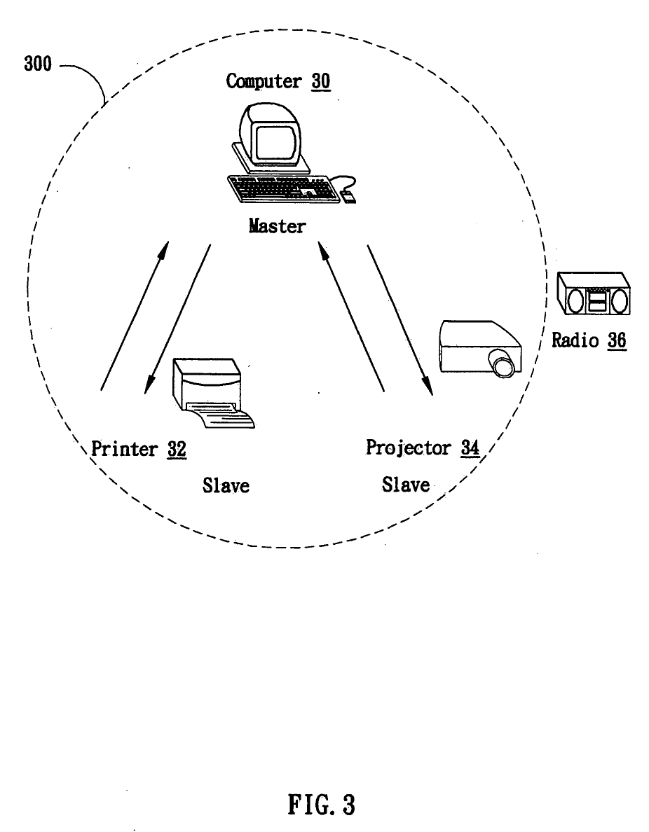

The fundamental unit of Bluetooth network is a piconet. Among a Bluetooth piconet, all Bluetooth devices are equal. Before establishing a Bluetooth piconet, all Bluetooth devices listen to particular frequency bands and search if there are other Bluetooth devices around. Although Bluetooth network is an ad-hoc network, it still maintains master-slave hierarchy during communication. A master handles the communication (i.e., clock synchronization, transmission rate . . . etc.) of a Bluetooth piconet, when a Bluetooth device intends to transmit data to another Bluetooth device. Basically the sender becomes master and the receiver becomes slave for establishing a simplest Bluetooth piconet. A Bluetooth piconet has only one “master” but at least seven “slaves”, and every Bluetooth device may participate several Bluetooth piconet simultaneously. FIG. 3 depicts the diagram of a simple Bluetooth piconet 300, herein contains four apparatus having Bluetooth devices—a computer 30, a printer 32, a projector 34, and a radio receiver 36. During idle status, each Bluetooth device scans particular frequency bands for inquiring other Bluetooth devices around. When computer 30 intends to print a document and display on screen, computer 30, printer 32, and projector 34 will establish a Bluetooth piconet 300, wherein computer 30 is master and printer 32 and projector 34 are slaves, to exchange data between two pairs of master-slave device.

According to foregoing description, we found that Bluetooth piconet matches the wireless remote control system—a master console handles a plurality of controllable devices and basically no communication requirement between controllable devices. Moreover, since Bluetooth supports some common wired/wireless communication technologies, such as RS232 and IrDA, so that utilizing Bluetooth as the wireless communication interface of the remote controller is able to efficiently integrate different kind of controllable devices and adaptive to the wireless remote control system. Hence, a Bluetooth voice-activated remote control system is disclosed below for a preferred embodiment of the invention.

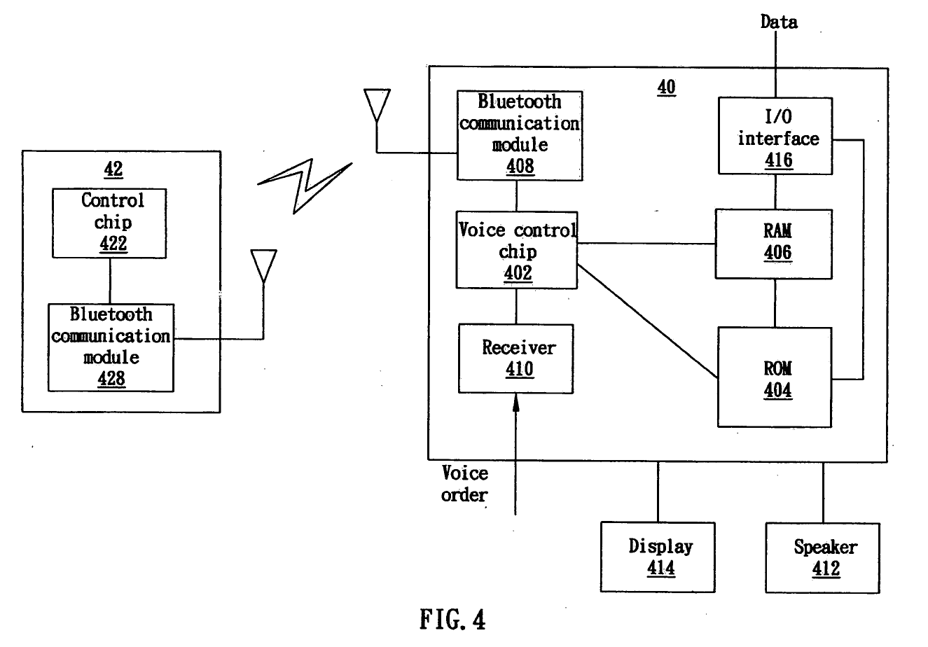

FIG. 4 illustrates a remote control system with Bluetooth. The present Bluetooth remote controller 40 contains: a voice control chip 402, a rewritable and programmable ROM 404, a RAM 406, a Bluetooth communication module 408, and a receiver 410. Controllable device 42 basically contains a Bluetooth communication module 428 and a control chip 422. Also, Bluetooth remote controller 40 may further comprise a speaker 412 or a display 414 as the man-machine interface, furthermore, an I/O interface 416 for inputting each kind of data (i.e., voice training records) into ROM 404 or RAM 406.

As mentioned before, Bluetooth remote controller 40 and controllable device 42 detects each other automatically when they are close by, hence no human operations are needed to configure the communication network. When there are some controllable devices appeared around, Bluetooth remote controller 40 detects and records their information (device ID, classification . . . etc.), and their supportive service functions. According to Bluetooth, no additional communication interface identification module (described in first embodiment) is needed anymore.

When a user gives a voice order and intends to handle a controllable device 42 to execute particular service function, firstly the voice order has to input the Bluetooth remote controller 10 through the receiver 410. Receiver 410 converts voice into electrical signals; usually it's made of a microphone.

After inputting the receiver 410, a user's voice order then inputs the voice control chip 402. Voice control chip 402 is the core of the remote controller 40, which contains three major parts: signal process module, speech recognition module, and a code synthesizer (not shown in the drawing). As well as aforementioned embodiment of the invention, signal process module is used to transform the analog voice signals into digital voice signals, and, in order to reduce data size, the digital voice signals will be compressed in advance. Speech recognition module compares the vocal characteristics of the user's voice order (i.e., perform spectrum analysis on saying compressed digital voice data) with a service function file to acquire the desired service function of the user. The service function file defines the corresponding relations between wordings and service functions, for example, the wording “turn on”, “open” corresponds to a service function of “initialize a device” is recorded in the service function file. Code synthesizer determines if the acquired service functions compose a complete, meaningful order and generates corresponding control codes. It's noticed that, when the user's voice order is meaningless (i.e., asking a refrigerator tuning to channel 56), or the designate device doesn't support the service function, the Bluetooth remote controller 40 will show messages on display 414 or a speaker 412 beeps to notice user of reentry his voice order. If a valid service function is obtained, a code synthesizer generates the corresponding control codes and transmits them to the Bluetooth communication module 406.

The service function file containing the users' voice training records is stored in ROM 414. Similarly, the voice training may be performed to update the service function file directly on the remote controller 40, or relevant voice training performed in other places but import through the I/O interface 416.

After receives the control code, the Bluetooth communication module 406 establishes connection and transmits radio signals containing saying control codes to the designate controllable devices. Because a Bluetooth piconet may have seven “slaves” at most, therefore the present Bluetooth remote controller 40 may handle at most seven controllable devices simultaneously.

As to the controllable device 42, the Bluetooth communication module 428 receives and decodes the transmitted radio signals from the Bluetooth communication module 408 into original control code to the control chip 422. As mentioned, both Bluetooth communication modules 408, 428 are identical. In next, control chip 422 drives the controllable device 42 to execute the user's order according to the control code.

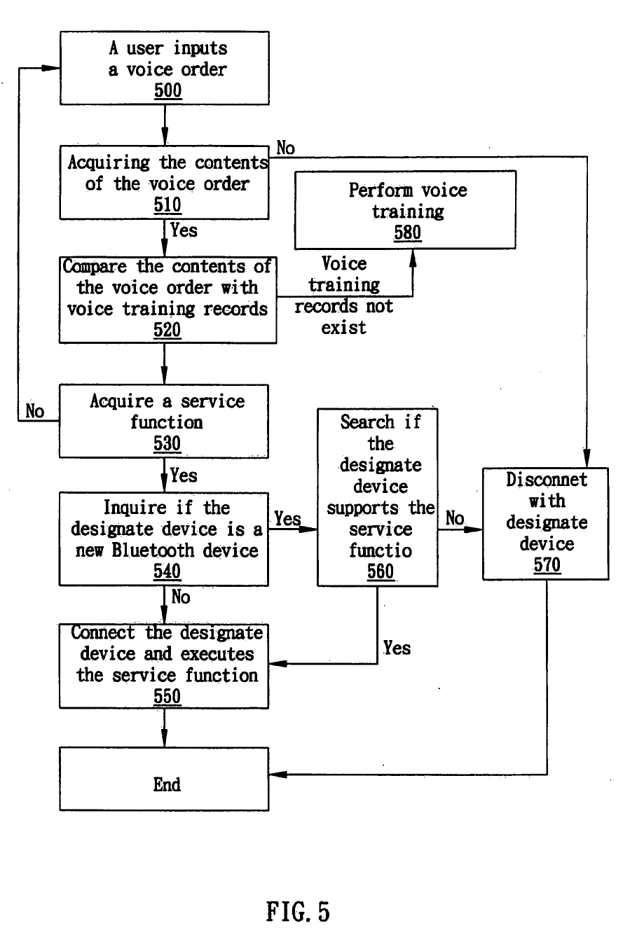

FIG. 5 depicts the flow chart of aforementioned Bluetooth remote controller activates. Firstly a user inputs a voice order (step 500), and then the Bluetooth control device performs relevant voice signal process on the input voice order for acquiring contents of the voice order (step 510). If the contents of user's voice order are acquired, the Bluetooth control device compares them with the voice training records (step 520), otherwise the Bluetooth control device disconnects with the controllable devices (step 570). Usually, voice-training records are recorded in a service function file and stored in the ROM of the Bluetooth control device. In step 520, if no voice training records are recorded in the service function file the Bluetooth control device will ask the user performing voice training in first for (step 580). Else if the voice training records exist, the Bluetooth control device tries to extract the desired service function of the user (step 530). When the content of the user's voice order could not form to a meaningful service function, the Bluetooth control device will return step 500 to ask the user re-inputting his voice order, else the Bluetooth control device inquires if the designate controllable device is a new Bluetooth device (step 540). Afterward, the Bluetooth control device connects with the controllable device for executing the desired service function of the user (step 550). The Bluetooth control device searches if the controllable device supports the service function (step 560), if yes, go to step 550 otherwise the Bluetooth control device will disconnect with the controllable device (step 570).

Although specific embodiments have been illustrated and described, it will be obvious to those skilled in the art that various modifications may be made without departing from what is intended to be limited solely by the appended claims.

What is claimed is:

1. A voice-activated remote control system comprising:
a receiver for receiving a user's voice order;
a voice process and recognition system electrically coupling with said receiver for recognizing contents of said voice order to generate a control code; and
a communication module electrically coupling with said voice process and recognition system, which encodes said control code into radio signals in a wireless communication format for transmitting to at least a designate controllable device.

2. The voice-activated remote control system of claim 1, wherein said voice process and recognition system comprises:
a signal process module for converting said voice order into a digital voice signal;
a speech recognition module electrically coupling with said signal process module, said speech recognition module analyzes said digital voice signal to obtain a service function in accordance with a service function file; and
a code synthesizer electrically coupling with said speech recognition module for generating said control code according to said service function.

3. The voice-activated remote control system of claim 2, wherein said service function file comprises voice training records for acquiring said contents of said voice order.

4. The voice-activated remote control system of claim 3, wherein said service function file further comprises a plurality of corresponding relations between said contents to said service functions.

5. The voice-activated remote control system of claim 2, wherein said service function file is stored in a ROM and said service function file may update and import through an I/O interface.

6. The voice-activated remote control system of claim 1, wherein said wireless communication format consists of Bluetooth, IrDA, IEEE 802.11, or WAP standard.

7. The voice-activated remote control system of claim 1, wherein said communication module further comprises a communication interface identification module for identifying the communication interfaces of said controllable devices.

8. A voice-activated remote control method comprising the steps of:
inputting a voice order of inquiring or controlling at least a controllable device into a wireless control device;
said wireless control device recognizing said voice order for generating a control code;
said wireless control device identifying radio formats of said controllable devices;
said wireless control device encoding said control code into radio signals within said radio format; and
said wireless control device transmitting said radio signals to said controllable devices for executing said voice order.

9. The voice-activated remote control method of claim 8, wherein said recognizing step comprises:
said wireless control device converting said voice order into a digital voice signal;
analyzing said digital voice signal with voice training records for acquiring contents of said voice order; and
generating a corresponding service function in accordance with said contents of said voice order.

10. The voice-activated remote control method of claim 8, wherein said controllable device transmits a plurality of supportive service function information to said wireless control device.

11. The voice-activated remote control method of claim 8 further comprising asking the user re-inputting said voice order when said wireless device couldn't recognize said voice order, said wireless control device couldn't acquire said service function, or said controllable device doesn't support said service function.

12. A Bluetooth voice-activated remote controller comprising:
a receiver for receiving a user's voice order;
a ROM for storing a service function file;
a RAM for temporally storing relevant data of said Bluetooth voice-activated remote controller;
a voice control chip electrically coupling with said receiver, said ROM, and said RAM for recognizing contents of said voice order to generate a control code according to said service function file; and
a Bluetooth communication module for encoding said control code into a Bluetooth radio signal and further transmitting said Bluetooth radio signal to at least a controllable device.

13. The Bluetooth voice-activated remote controller of claim 12, wherein said voice control chip comprises:
a signal process module for converting said voice order into digital voice signals;
a speech recognition module electrically coupling with said signal process module, said speech recognition module analyzes said digital voice signal to obtain a service function in accordance with said service function file; and
a code synthesizer electrically coupling with said speech recognition module for generating said control code according to said service function.

14. The Bluetooth voice-activated remote controller system of claim 12, wherein said service function file comprises voice training records for acquiring said contents of said voice order.

15. The Bluetooth voice-activated remote controller of claim 12, wherein said service function file may update and import through an I/O interface.

16. The Bluetooth voice-activated remote controller of claim 12 further comprises a display panel or a speaker.

17. A voice-activated remote control method with Bluetooth communication interface, said voice-activated remote control method comprises the steps of:
inputting a voice order of inquiring or controlling at least a controllable device to a Bluetooth control device;
said Bluetooth control device recognizing said voce order for acquiring a service function and further compressing said service function into a control code;
said Bluetooth control device establishing a Bluetooth piconet with said controllable devices;
said Bluetooth control device encoding said control code into a radio signal within Bluetooth format; and
said Bluetooth control device transmitting said radio signal to said controllable devices for executing said voice order.

18. The voice-activated remote control method of claim 17, wherein said recognizing step comprising:
said Bluetooth control device converting said voice order into a digital voice signal;
analyzing said digital voice signal with voice training records for acquiring contents of said voice order; and
generating a corresponding service function in accordance with said contents of said voice order.

19. The voice-activated remote control method of claim 18, wherein said Bluetooth control device disconnects with said controllable device when said Bluetooth control device couldn't recognize said voice order or said controllable device doesn't support said service function.

20. The voice-activated remote control method of claim 17 further asking the user re-inputting said voice order when said Bluetooth control device couldn't acquire said service function.
